(19) United States
(12) Patent Application Publication
(10) Pub. No.: US 2026/0056533 A1
(43) Pub. Date: Feb. 26, 2026

(54) Method for Constructing at Least One Tool Set Having at Least Two Tools, Device for Data Processing, Computer Program and Computer-Readable Storage Medium

(71) Applicant: Bayerische Motoren Werke Aktiengesellschaft, Muenchen (DE)

(72) Inventors: Aurelie DEGROOTE, Muenchen (DE); Ingo HEINLE, Inzell (DE); lrum MAQSOOD, Muenchen (DE)

(21) Appl. No.: 19/105,144

(22) PCT Filed: Sep. 27, 2023
(86) PCT No.: PCT/EP2023/076712

§ 371 Date: Feb. 20, 2025

(30) Foreign Application Priority Data
Oct. 18, 2022 (DE) 10 2022 127 158.7

(51) Int. Cl. G05B 19/418

(52) U.S. Cl. CPC G05B 19/4184

(57) ABSTRACT

A method for constructing at least one tool set, which includes at least two first tools, by which method at least two first components can be processed simultaneously in one stroke of a press. A first tool set is constructed based on a determined performance characteristic value. The performance characteristic value characterizes a manufacturing process executed to process at least two further components in a respective stroke of the press or of a further press simultaneously by means of two further tools of a respective further tool set.

### BACKGROUND AND SUMMARY

The invention relates to a method for constructing at least one tool set having at least two tools. The invention also relates to a data processing device. Furthermore, the invention relates to a computer program and to a computer-readable storage medium.

U.S. Pat. No. 9,922,345 B2 discloses a computer-implemented method. A computer-implemented method is also known from U.S. Pat. No. 8,560,366 B2.

An object of the present invention is to provide a method, a data processing device, a computer program and a computer-readable storage medium, such that at least one tool set having at least two tools for machining, in particular forming, components can be constructed and subsequently manufactured, for example, in a particularly advantageous manner.

At least this object is achieved by the devices, methods, computer programs, and computer-readable storage mediums having one or more of the features described herein.

A first aspect of the invention relates to a method for constructing and, for example, subsequently manufacturing at least one first tool set comprising at least or exactly two first tools. The first tools, and therefore the first tool set, are provided, designed or constructed and, in particular, manufactured to simultaneously machine, in particular form, very particularly deep-draw, and/or cut, very particularly punch, at least two first components in a stroke, in particular a single stroke, of a press. This means that the press, for example the hydraulic or mechanical press, in its fully manufactured state, comprises the first tool set and therefore the first tools, wherein the first tools and therefore the first tool set are to be constructed, in particular manufactured, in or by the method according to the invention. The construction of the first tools and therefore of the first tool set is also referred to as design, in particular constructional design, of the first tools and therefore of the first tool set. In particular, the first tools can be used to simultaneously machine the two first components in said stroke of the press in such a manner that one of the first components can be or is machined by means of one of the tools and the other one of the first components can be or is machined by means of the other one of the first tools in or during or by the stroke of the press, wherein or while, for example, the first components and therefore, in particular, the first tools are arranged beside one another, in particular viewed in or along a horizontal plane. In particular, provision is made for the one of the first components to not be machined by the other one of the first tools in the stroke, and provision is made, in particular, for the other one of the first components to not be machined by the one of the first tools in the stroke. A plurality of tool sets, for example in a press line, form a set of tools. In other words, all tools in a press line are collectively also referred to as a set of tools and therefore form a set of tools.

In general terms, components which are machined simultaneously or in parallel in a stroke of a press, in particular in the manner described above, form a combination which is also referred to as a variant, a component variant or a component combination, such that, for example with regard to the first tools and the first components, the first components form a first combination which is also referred to as a first variant, a first component variant or a first component combination. This shall be explained in more detail using the following example: during mass or series production of vehicles, which are, for example, in the form of motor vehicles, in particular automobiles and very particularly passenger vehicles, both front flaps and rear flaps are manufactured, for example, for a vehicle series or for a vehicle derivative in order to manufacture a plurality of individual vehicles of the respective vehicle series or the respective vehicle derivative from the manufactured front flaps and from the manufactured rear flaps. In its completely manufactured state, the respective vehicle of the vehicle series, simply also referred to as a series, therefore comprises, in particular exactly, one of the manufactured front flaps and, in particular exactly, one of the manufactured rear flaps. The respective front flap is manufactured, for example, from at least one respective front flap component, and the respective rear flap is manufactured, for example, from at least one respective rear flap component. For this purpose, for example, the respective front flap component and the respective rear flap component are machined, in particular formed and/or cut. In order to be able to manufacture the front flaps and the rear flaps and therefore the vehicles in a timely and cost-effective manner, in particular exactly, one of the front flap components and, in particular exactly, one of the rear flap components form, for example, in particular exactly, one respective component combination which is machined. This should be understood as meaning the fact that the respective front flap component of the respective component combination and the respective rear flap component of the respective component combination are simultaneously machined by means of respective tools in one stroke of a press, such as the press mentioned above, in particular while, for example, the front flap component of the component combination and the rear flap component of the component combination are arranged beside one another, in particular viewed along a horizontal plane. In this example, the front flap component can be considered to be one of the first components and the rear flap component can be considered to be the other one of the first components, for example. Accordingly, the tools which are used to machine the respective front flap component of the respective component combination and the respective rear flap component of the respective component combination can be considered to be the first tools, for example. The machining of the components can also be referred to in simple terms as machining of the respective component combination, and vice versa. In other words, if the text below refers to the fact that a or the respective component combination is or was machined, this should be understood as meaning that the components of the component combination have been, are or were machined.

Tool sets and therefore tools are usually newly developed, constructed and manufactured for vehicles to be newly manufactured in a vehicle series that has been newly developed and therefore is to be newly manufactured, which is usually a time-consuming and expensive process. As explained in yet more detail below, the method according to the invention makes it possible to resort to production processes which have already been carried out and have therefore been carried out in the past and in which or by means of which component combinations were machined in order to thereby manufacture vehicles of an older vehicle series, for example.

In order to therefore now be able to construct and, for example, subsequently manufacture the first tools and therefore the first tool set in a particularly timely and cost-effective manner, provision is made in the method according to the invention for at least one respective performance characteristic value which belongs to the respective manufacturing process to be determined, in particular by means of an electronic computing device, for a plurality of manufacturing processes that have already been carried out. This preferably means that the method is carried out by said electronic computing device. The respective performance characteristic value belonging to the respective manufacturing process characterizes or describes the respective associated manufacturing process that therefore belongs to the respective performance characteristic value, in particular with regard to successful performance of the respective manufacturing process and/or with regard to productivity of the respective manufacturing process. In particular, the manufacturing processes may be the above-mentioned production processes, to which recourse is made in the method. The feature stating that the manufacturing processes have already been or were carried out should be understood as meaning the fact that the manufacturing processes are in the past, in particular with regard to a first point in time at which the method according to the invention is carried out, in particular started, that is to say before the first point in time and, in particular, have been or were concluded and therefore have been or were ended before the first point in time.

The respective manufacturing process that has already been carried out comprises at least one respective associated work process, that is to say a work process belonging to the respective manufacturing process. The respective work process was carried out multiple times in succession in the respective associated manufacturing process, in particular considered over a period of time. In the respective work process of the respective associated manufacturing process, at least two further components were simultaneously machined, in particular formed and very particularly deep-drawn, and/or cut, in particular punched, by means of two further tools of a respective further tool set in a respective stroke of the above-mentioned press or of a further press. This shall be explained using the following example: the respective two further components are or were, for example, respective semi-finished products such as plates, in particular sheet metal plates. For example, in the respective work process, the respective two plates were placed into the press or the further press and were simultaneously machined by means of the further two tools by the respective stroke of the press or of the further press in such a manner that the respective two plates were simultaneously formed, in particular deep-drawn, and/or cut, in particular punched. The respective two plates therefore formed a respective component combination in the respective work process.

Furthermore, provision is made in the method according to the invention for the first tool set, and therefore the first tools, to be constructed and in particular manufactured on the basis of the determined performance characteristic values, in particular by means of the electronic computing device.

Tool sets and therefore tools for tool sets are usually constructed, in particular, solely on the basis of human experience. This may result in a plurality of, possibly time-consuming and costly, prototypes having to be constructed and/or test series having to be carried out in order to construct the first tools and therefore the first tool set, for example, in such a manner that the first components can be machined by means of the first tool set as desired, that is to say, in particular, in a sufficiently timely and cost-effective manner and with sufficient quality. This may result in a time-consuming and costly process. In contrast, the invention now makes it possible to resort to the work processes that have already been carried out and therefore the manufacturing processes that have already been carried out or to take into account the work processes and manufacturing processes that have already been carried out in order to create at least one advantageous starting point therefrom, that is to say from the performance characteristic values, in order to be able to construct and, in particular, subsequently manufacture the first tools and therefore the first tool set in a timely and cost-effective manner proceeding from the starting point in order to be able to machine the first components in an advantageous manner, in particular in a timely and cost-effective manner, in particular after the first tool set and therefore the first tools have been manufactured.

The performance characteristic values may be or comprise performance indicators or may be referred to as performance indicators, wherein the respective performance indicator is also referred to as a KPI (Key Performance Indicator). The performance indicators characterize or describe, for example, whether and/or how often the stroke of the press or of the further press was carried out without disruption in the manufacturing processes, in particular while they are respectively being carried out. Alternatively or additionally, the performance characteristic values describe or characterize, for example, an hourly performance, that is to say a number of strokes in production per total process time. Alternatively or additionally, the performance characteristic values describe or characterize a stroke application per hour and/or a performance indicator, in particular for each installation and period. Alternatively or additionally, the performance characteristic values describe or characterize, for example, a first pass yield that results from a difference divided by an actual quantity, wherein the difference results from the actual quantity minus a quantity of rejects, therefore rejects minus reworking, that is to say the first pass yield is a proportion of parts delivered directly to a customer or buyer in comparison with the produced parts, in particular taking into account reworking, for each installation. In particular, the performance characteristic values describe or characterize, for example, problem-free performance or a degree of problem-free performance of the manufacturing processes. In particular, it is conceivable for the performance characteristic values to describe or characterize a reject rate and/or an amount of reworking and/or productivity of the manufacturing processes.

By taking into account the manufacturing processes that have already been carried out, at least or exactly one of the manufacturing processes that have already been carried out can be used as a reference process, for example. This should be understood as meaning, in particular, the fact that the further tools used in the reference process can be used, in particular, as a starting basis, proceeding from which the first tools can be constructed and, in particular, subsequently manufactured in a timely and cost-effective manner. This makes it possible to avoid, for example, an excessive experience-based and/or random start of the construction of the first tool parts. In particular, the manufacturing processes and therefore the component combinations which were machined in the manufacturing processes are assessed, in particular relative to one another, by means of the performance characteristic values, for example. This assessment makes it possible to provide an advantageous starting basis, proceeding from which the first tools and therefore the first tool set can be constructed and subsequently preferably manufactured in a particularly timely and cost-effective manner. The invention therefore makes it possible to use the assessment of the manufacturing processes and therefore of the component combinations to configure the first tools and therefore the first tool set and subsequently a new, further manufacturing process in which the first components are or can be machined by means of the first tools.

In order to be able to provide a particularly advantageous starting basis for the construction of the first tools and therefore of the first tool set, such that the first tools and therefore the first tool set can be constructed and, in particular, subsequently manufactured in a particularly timely and cost-effective manner, one embodiment of the invention provides for a sequence of performance characteristic values to be created, in particular by means of the electronic computing device, according to a predefined or predefinable rule, wherein the first tool set, that is to say the first tools, is/are constructed on the basis of the sequence of performance characteristic values. For example, the manufacturing process whose performance characteristic value(s) is/are highest or lowest is used as a reference process. In particular, the manufacturing process that is first or last in the sequence of performance characteristic values is used, for example, as a reference process in order to be able to subsequently construct and in particular subsequently manufacture the first tools and therefore the first tool set in a particularly timely and cost-effective manner. The sequence of performance characteristic values is also referred to as a performance characteristic value sequence.

The performance characteristic values are sorted, for example, in the performance characteristic value sequence, in particular in such a way that they are sorted in an ascending or descending manner. If, for example, the greatest performance characteristic value is the best one in the ascending sorting, the performance characteristic value that is last in the performance characteristic value sequence or the manufacturing process characterized by the performance characteristic value that is last in the performance characteristic value sequence is used, for example, as a reference process. This may be the case, in particular, when the respective performance characteristic value characterizes a respective quality of the respective associated manufacturing process. If, for example, the greatest performance characteristic value in the descending sorting of the performance characteristic values is the best one, the performance characteristic value that is first in the performance characteristic value sequence or the manufacturing process characterized by the performance characteristic value that is first in the performance characteristic value sequence is used, for example, as a reference process. This may be the case, in particular, when the respective performance characteristic value characterizes the respective quality of the respective associated manufacturing process.

If, for example, the smallest performance characteristic value in the ascending sorting is the best one, the performance characteristic value that is first in the performance characteristic value sequence or the manufacturing process characterized by the performance characteristic value that is first in the performance characteristic value sequence is used, for example, as a reference process. This may be the case, in particular, when the respective performance characteristic value characterizes a reject rate or a cycle time of the respective associated manufacturing process. If, for example, the smallest performance characteristic value in the descending sorting of the performance characteristic values is the best one, the performance characteristic value that is last in the performance characteristic value sequence or the manufacturing process characterized by the performance characteristic value that is last in the performance characteristic value sequence is used, for example, as a reference process. This may be the case, in particular, when the respective performance characteristic value characterizes the reject rate or the cycle time of the respective associated manufacturing process.

A further embodiment is distinguished by the fact that first ones of the manufacturing processes are assigned to a first manufacturing process type, in particular by means of the electronic computing device, on the basis of at least one first criterion. Provision is also made for second ones of the manufacturing processes to be assigned to a second manufacturing process type, in particular by means of the electronic computing device, on the basis of at least one second criterion. The manufacturing processes are therefore divided into the manufacturing process types on the basis of the criteria. This makes it possible to achieve an advantageous comparability, in particular such that, for example, only those manufacturing processes whose further components are identical or at least similar to one another and/or with respect to the first components to be manufactured are taken into account. The first tools and therefore the first tool set can therefore be constructed in a particularly timely and cost-effective manner.

For example, the respective criterion comprises respective names or designations of the respective components. The first criterion is therefore satisfied if the names or designations of the further components which were machined during the work processes of the first manufacturing processes are the same. Accordingly, for example, the second criterion is satisfied if the names or designations of the further components which were machined during the work processes of the second manufacturing processes are the same.

A further, particularly advantageous embodiment of the invention provides for the first manufacturing processes to be assigned to the first manufacturing process type if the first criterion is satisfied. In this case, the first criterion is satisfied if at least one difference between a first value and a second value is less than a predefinable or predefined threshold value. The first value characterizes or describes at least one of the further components which were machined during the work processes of the first manufacturing processes. Alternatively or additionally, the first value characterizes or describes at least one of the first manufacturing processes. The second value describes or characterizes another one of the further components which were machined during the work processes of the first manufacturing processes. Alternatively or additionally, the second value characterizes or describes at least another one of the first manufacturing processes.

Alternatively or additionally, the first criterion is satisfied, for example, if at least one difference between a respective value, also referred to as a first comparison value, and at least one value, also referred to as a first component value, is less than a predefinable or predefined threshold value. For example, the first comparison value characterizes or describes the respective further component that was machined in the respective work process of the first manufacturing processes. Alternatively or additionally, the first comparison value characterizes or describes, for example, the respective first manufacturing process. For example, the first component value describes or characterizes at least or exactly one of the first components to be manufactured and/or a planned manufacturing process which is to be carried out by means of the first tools and comprises, for example, at least one planned work process in which the first components are machined by means of the first tools.

Provision is also made for the second manufacturing processes to be assigned to the second manufacturing process type if the second criterion is satisfied, wherein the second criterion is satisfied if at least one difference between a third value and a fourth value is less than a predefinable or predefined threshold value. The third value describes or characterizes one of the further components which were machined during the work processes of the second manufacturing processes. Alternatively or additionally, the third value characterizes or describes at least one of the second manufacturing processes. The fourth value characterizes or describes another one of the further components which were machined during the work processes of the second manufacturing processes. Alternatively or additionally, the fourth value describes or characterizes at least another one of the second manufacturing processes.

Alternatively or additionally, the second criterion is satisfied, for example, if at least one difference between a respective value, also referred to as a second comparison value, and at least one value, also referred to as a second component value, is less than a predefinable or predefined threshold value. For example, the second comparison value characterizes or describes the respective further component that was machined during the respective work process of the second manufacturing processes. Alternatively or additionally, the second comparison value characterizes or describes, for example, the respective second manufacturing process. The second component value describes or characterizes, for example, at least or exactly one of the first components to be manufactured and/or the planned manufacturing process.

This makes it possible to ensure, for example, that only those manufacturing processes in which the further components that are at least similar or identical to one another and/or are at least similar or identical with respect to the first components to be manufactured were machined are taken into account for constructing the first tool set. This makes it possible to achieve, in a particularly timely and cost-effective manner, a particularly advantageous starting basis, proceeding from which the first tools and therefore the first tool set can be constructed and, in particular, subsequently manufactured in a particularly timely and cost-effective manner.

Therefore, the differences mentioned characterize or describe, for example, similarities between the further components and/or similarities between the further components that have already been machined and the first components to be manufactured or machined. The similarities describe, for example, similarities with regard to a respective wall thickness of the components, which is formed in particular as a sheet thickness, with the result that, for example, only those manufacturing processes in which components that have or had a similar or identical wall thickness, in particular sheet thickness, to one another and/or with respect to the first components were machined are taken into account. In summary and in simple terms, the respective criterion is therefore satisfied when the further components are at least similar or identical to one another and/or when the further components are at least similar or identical to the first components.

In this case, it has been shown to be particularly advantageous if the values characterize the same property of the respective component and/or of the respective manufacturing process. This means that, for example, the first value and the second value relate to the same property of one of the further components and one of the first components, thus making it possible to construct and, in particular, manufacture the first tools in a particularly timely and cost-effective manner. The property of the respective manufacturing process may be or comprise, for example, a number of presses in a press line that are used in the respective manufacturing process, a respective type of the respective press etc.

A further embodiment is distinguished by the fact that the property is or comprises a wall thickness and/or a material from which the respective component is formed, and/or a degree of forming and/or a dimension, in particular an outer dimension, in particular of the respective component. This makes it possible to ensure in a particularly timely and cost-effective manner that only those manufacturing processes which have already been carried out and are therefore in the past and whose components were or are at least similar to the first components to be manufactured or machined are taken into account.

A further embodiment is distinguished by the fact that at least one overall characteristic value characterizing the respective manufacturing process type is determined for the respective manufacturing process type from the performance characteristic values of the manufacturing processes assigned to the respective manufacturing process type. The overall characteristic value therefore describes or characterizes the respective associated process type, and so these can be compared with one another particularly well, quickly and simply.

In order to be able to construct and subsequently manufacture, for example, the first tool set in a particularly timely and cost-effective manner, a further configuration of the invention provides for the first tool set to be constructed on the basis of the overall characteristic values.

In order to be able to compare the process types with one another in a particularly advantageous, simple and fast manner, a further configuration of the invention provides for a sequence of overall characteristic values, also referred to as an overall characteristic value sequence, to be created, in particular by means of the electronic computing device, according to a predefined or predefinable rule. The statements above and below relating to the sequence of performance characteristic values can also be readily applied to the sequence of overall characteristic values, and vice versa.

In this case, it has been shown to be particularly advantageous if the first tool set is constructed on the basis of the sequence of overall characteristic values. This makes it possible to construct and, for example, subsequently manufacture the first tools in a particularly timely and cost-effective manner.

The manufacturing processes and the process types shall now be explained in more detail using the following example: in a first one of the manufacturing processes that is also referred to as a first flap process, front flap outer parts and front flap inner parts for a first series of a motor vehicle are manufactured, for example. For this purpose, two of the further components are each simultaneously machined, for example, during the work process of the first flap process in order to manufacture one of the front flap outer parts for the first series from a first one of the respective two further components and to manufacture one of the front flap inner parts for the first series from the second one of the respective two further components. Since the work process of the first flap process is performed multiple times in succession, the plurality of front flap outer parts for the first series and the plurality of front flap inner parts for the first series are manufactured in or by the first flap process.

In a second one of the manufacturing processes that is also referred to as a second flap process, front flap outer parts and front flap inner parts for a second series of a motor vehicle are manufactured, for example. For this purpose, two of the further components are each simultaneously machined, for example, during the work process of the second flap process in order to manufacture one of the front flap outer parts for the second series from a first one of the respective two further components and to manufacture one of the front flap inner parts for the second series from the second one of the respective two further components. Since the work process of the second flap process is performed multiple times in succession, the plurality of front flap outer parts for the second series and the plurality of front flap inner parts for the second series are manufactured in or by the second flap process.

In a third one of the manufacturing processes that is also referred to as a first wheelhouse process, first wheelhouse parts and second wheelhouse parts for a third series of a motor vehicle are manufactured, for example. For this purpose, two of the further components are each simultaneously machined, for example, during the work process of the first wheelhouse process in order to manufacture one of the first wheelhouse parts for the third series from a first one of the respective two further components and to manufacture one of the second wheelhouse parts for the third series from the second one of the respective two further components. Since the work process of the first wheelhouse process is performed multiple times in succession, the plurality of first wheelhouse parts for the third series and the plurality of second wheelhouse parts of the third series are manufactured in or by the first wheelhouse process.

In a fourth one of the manufacturing processes that is also referred to as a second wheelhouse process, third wheelhouse parts and fourth wheelhouse parts for a fourth series of a motor vehicle are manufactured, for example. For this purpose, two of the further components are each simultaneously machined, for example, during the work process of the second wheelhouse process in order to manufacture one of the third wheelhouse parts for the fourth series from a first one of the respective two further components and to manufacture one of the fourth wheelhouse parts for the fourth series from the second one of the respective two further components. Since the work process of the second wheelhouse process is performed multiple times in succession, the plurality of third wheelhouse parts for the fourth series and the plurality of fourth wheelhouse parts for the fourth series are manufactured in or by the second wheelhouse process.

For example, the first flap process and the second flap process are the first manufacturing processes that are assigned to the first process type. For example, the first wheelhouse process and the second wheelhouse process are the second manufacturing processes that are assigned to the second process type.

For example, the first flap process and the second flap process are assigned to the first process type since, for example, the front flap outer parts from the first flap process and/or the front flap inner parts from the first flap process are similar or identical to the front flap outer parts from the second flap process and/or to the front flap inner parts from the second flap process and/or since the front flap outer parts from the first flap process and/or the front flap inner parts from the first flap process and/or the front flap outer parts from the second flap process and/or the front flap inner parts from the second flap process are identical or similar to the first components.

For example, the first wheelhouse process and the second wheelhouse process are assigned to the second process type since, for example, the first wheelhouse parts from the first wheelhouse process and/or the second wheelhouse parts from the first wheelhouse process are similar or identical to the third wheelhouse parts from the third wheelhouse process and/or to the fourth wheelhouse parts from the fourth wheelhouse process and/or since the first wheelhouse parts from the first wheelhouse process and/or the third wheelhouse parts from the third wheelhouse process and/or the fourth wheelhouse parts from the fourth wheelhouse process are identical or similar to the first components.

In particular, it is conceivable for the respective above-mentioned sequence, and therefore the sequence of performance characteristic values and/or the sequence of overall characteristic values, to be formed on the basis of the described similarity of the further components to one another and/or with respect to the first components. For this purpose, the respective similarity, that is to say for example a respective similarity value describing the respective similarity, is used, for example, as a weighting, and therefore as a weighting factor, wherein the respective performance characteristic value and/or the respective overall characteristic value is/are multiplied by the respective weighting factor, for example. The respective similarity or the respective similarity value may therefore be a component part of the respective rule, according to which the respective sequence is formed. In particular, it is conceivable for each individual performance characteristic value and/or overall value to be weighted individually in order to thereby calculate, for example, the respective overall characteristic value from the individual weighted performance characteristic values and/or to calculate a higher-level overall value from the individual weighted overall characteristic values. For this purpose, the weighted performance characteristic values or overall characteristic values, that is to say the performance characteristic values or overall characteristic values multiplied by the respective weighting factor, are added, for example.

It goes without saying that it is possible for a plurality of performance characteristic values characterizing the respective manufacturing process to be able to be determined for the respective manufacturing process, wherein the statements above and below relating to the respective performance characteristic value of the respective manufacturing process can also be readily applied to the plurality of performance characteristic values of the respective manufacturing process, and vice versa.

A second aspect of the invention relates to a data processing device, wherein the data processing device comprises means for carrying out the method according to the first aspect of the invention. Advantages and advantageous configurations of the first aspect of the invention can be considered to be advantages and advantageous configurations of the second aspect of the invention, and vice versa.

A third aspect of the invention relates to a computer program which is also referred to as a computer program product and is also simply referred to as a program. The computer program according to the third aspect of the invention comprises instructions which, when the computer program is executed by a computer, cause the computer to carry out the method according to the first aspect of the invention. Advantages and advantageous configurations of the first aspect and of the second aspect of the invention can be considered to be advantages and advantageous configurations of the third aspect of the invention, and vice versa.

Finally, a fourth aspect of the invention relates to a computer-readable storage medium comprising instructions which, when the computer-readable storage medium or the instructions is/are executed by a computer, cause(s) the latter to carry out the method according to the first aspect of the invention. Advantages and advantageous configurations of the first aspect, of the second aspect and of the third aspect of the invention can be considered to be advantages and advantageous configurations of the fourth aspect of the invention, and vice versa.

These and other details and aspects of the embodiments described herein will be apparent from the following detailed description in connection the associated drawings.

### BRIEF DESCRIPTION OF THE DRAWINGS

FIG. 1 shows a schematic side view of a press with a tool set comprising at least two tools which can be used to simultaneously machine at least two components in one stroke of the press; and

FIG. 2 shows a block diagram for illustrating a method for constructing the tool set of the press.

### DETAILED DESCRIPTION OF THE DRAWINGS

It will be understood that, in the figures, identical or functionally identical elements are provided with the same reference signs.

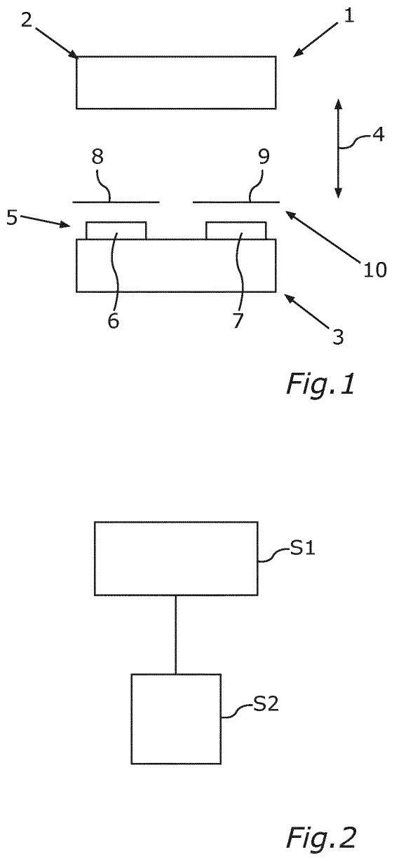

FIG. 1 shows a schematic side view of a press 1 which may be a component part of a press line, for example. In particular, the press 1 may be in the form of a mechanical press or a hydraulic press. The press 1 has two press parts 2 and 3 which are also referred to as tool halves or are in the form of tool halves and are opposite one another, in particular in a starting position of the press parts 2 and 3 that is shown in FIG. 1. The press 1 may perform a stroke in or during which the press parts 2 and 3 are moved relative to one another, along a direction of movement illustrated by a double-headed arrow in FIG. 1, in such a manner that the press parts 2 and 3 are moved toward one another.

In the exemplary embodiment shown in FIG. 1, the press part 3 comprises a tool set 5 which is also referred to as a first tool set. The tool set 5 comprises two tools 6 and 7 which are also referred to as first tools. The tools 6 and 7 can be used to machine two components 8 and 9, which are also referred to as first components, simultaneously, that is to say in parallel, in or during said stroke of the press 1. For this purpose, the components 8 and 9 are arranged between the press parts 2 and 3, considered along the direction of movement, in particular while the press parts 2 and 3 are in their starting position. The press 1 then performs the stroke, as a result of which the components 8 and 9 are simultaneously machined by means of the tools 6 and 7. It can be seen from FIG. 1 that the tools 6 and 7 and the components 8 and 9 are arranged beside one another, in particular during the stroke. Therefore, the component 8 is not machined by the tool 7 in the stroke and the component 9 is not machined by the tool 6 in the stroke. Again in other words, the component 8 is machined solely by means of the tool 6 with respect to the tools 6 and 7 in the stroke and the component 9 is machined solely by means of the tool 7 with respect to the tools 6 and 7 in the stroke. The machining of the respective component 8, 9 may comprise, for example, forming, in particular deep-drawing, of the respective component 8, 9. Alternatively or additionally, the respective machining of the respective component 8, 9 may comprise respective cutting, in particular respective punching, of the respective component 8, 9 and/or respective reshaping of the respective component 8, 9.

The components 8 and 9 form a combination 10 which is also referred to as a first combination. The combination is also referred to as a component combination, a first component combination, a variant, a first variant, a first component variant or a component variant. In simple terms, the machining of the components 8 and 9 in the stroke is also referred to as machining of the combination, and vice versa.

In order to now be able to construct and subsequently, in particular, manufacture the tools 6 and 7 and therefore the tool set 5 in a particularly timely and cost-effective manner, a method for constructing and, in particular, for manufacturing the tool set 5 and therefore the tools 6 and 7 is carried out. In this respect, FIG. 2 shows a block diagram that is used below to explain the method. In a first step S1 of the method, at least one respective performance characteristic value that belongs to the respective manufacturing process and characterizes the respective associated manufacturing process is determined for a plurality of manufacturing processes that have already been carried out and are therefore in the past with respect to a point in time at which the method is started. The method is carried out, for example, by means of an electronic computing device that is used to determine the performance characteristic values, for example.

The respective manufacturing process that has already been carried out and is therefore in the past respectively comprises at least one respective work process that was carried out multiple times in succession in the respective manufacturing process, in particular considered over a period of time. During the respective work process of the respective manufacturing process, at least two further components were simultaneously machined by means of two further tools of a respective further tool set in a respective stroke of the press 1 or of a further press, such that the two further components, for example, have formed a further combination in the same manner as the components 8 and 9 form the combination 10.

In a second step S2 of the method, the first tools 6 and 7 and therefore the first tool set 5 are constructed and, in particular, subsequently manufactured on the basis of the determined performance characteristic values, in particular by means of the electronic computing device.

The described method is based, in particular, on the following knowledge and considerations: the manufacturing of parts in the form of sheet metal components, for example, in particular for vehicles and in particular for bodies of vehicles in the form of self-supporting bodies, for example, comprises, for example, a plurality of process steps along or in a press line. An original plate is converted into a desired form, for example by forming and/or cutting the plate. For this purpose, the plate is formed, in particular deep-drawn, reshaped and/or cut and/or punched and/or perforated, for example. A part-specific tool, for example the respective tool 6, 7, is usually used for each of these processes. Press lines with a large press table make it possible, for example, to combine the manufacturing of a plurality of parts in one tool set, as was explained using the example of the press 1.

Such a combination of tools, for example the tools 6 and 7, and therefore a component combination, such as the combination 10, can lead to particularly advantageous, in particular particularly high, productivity of the press line, which is why this aspect should be carefully considered in a planning phase for a new product. The combination of parts, for example the combination 10 of the components 8 and 9 or the combination of the tools 6 and 7, is not a trivial task. For example, a mixing or combination of unfavorable materials, for example a combination of aluminum and steel, should be avoided, which may be relevant, in particular, to reuse, and therefore to recycling remainders. A mixing of materials or material types with respect to remainders, which result, for example, from cutting operations such as punching operations and accordingly remain, may result in a strong decrease in their value. In addition, the number of work processes for the parts that are combined should be similar. In this context, the content of the work processes should also be taken into account. If a plurality of slides are required, the available space on the press table may not suffice. A further aspect may be a different height of stacks which are also referred to as plate stacks and are used to manufacture different parts and are formed, for example, by plates being stacked on one another. In this case, for example, the component 8 is one of the plates in a plate stack and the component 9 is, for example, a plate in another plate stack. A robot arm that moves, in particular transports, the respective plate or the respective component 8, 9 to and, in particular, into the press 1 can usually receive a plurality of plates only when a current height difference between heights of the stacks is below a machine-dependent threshold value. Additional aspects can be taken into account for a deep-drawing process. A required force, also referred to as a blank holder force or holding force, of a blank holder, also referred to as a holder, for holding the parts, for example the components 8 and 9, during or in the stroke should be identical or similar since the binders (blank holders) of the associated drawing processes are in contact with a single drawing cushion that is also simply referred to as a cushion. It is also advantageous to make the drawing depth the same for all plates or components to be drawn, such as the components 8 and 9. In order to circumvent these restrictions or boundary conditions, springs could be installed. In addition, a force application point of press forces may also play an important role in order to avoid tilting of a press ram. The resulting force application point of the respective tool should be advantageously at least in the vicinity of a point of intersection of symmetry lines of a press table of the press 1. A respective size of the respective plate, also referred to as a blank, or of the respective component 8, 9 may possibly affect a choice of the respective combination since available space on the press table may be limited and machine-dependent, which may restrict a maximum extent of the respective tool in the form of a deep-drawing tool, for example, and consequently may also restrict an extent of the blanks. The performance of a component combination, for example the combination 10, can be examined and/or assessed using performance indicators, for example the performance characteristic values mentioned above, which are captured during production and therefore while performing the respective manufacturing process. Such variables, such as the quantity of rejects, reworking and/or productivity, may be available in databases. When interpreting such indicators and, in particular, when comparing production processes, for example the manufacturing processes, a similarity of the components should also be taken into account. Criteria for assessing the similarity of components may be their size, the material, the type of press line that is used for production, and the corresponding vehicle type for which the components 8 and 9 are manufactured or machined. The data relating to the similarity can be found, for example, in databases for the planning processes.

The method makes it possible to determine suitable combinations for a particular type of part with other types of part. In this context, a type of part can be considered to be a class comprising similar parts in terms of geometry and functionality from different products, for example automobile projects. In order to find possible combinations, use is made of the content of a database, for example, which may contain solutions used at present or in future in a pressing plant. An advantageous step in this context is a definition of classes of parts. A class might be all side bodies or side walls of a vehicle or of a body of a vehicle that are currently being produced or were produced in the past. A possible solution is a derivation of classes on the basis of names of parts. In general, it cannot be assumed that the names of parts are standardized. This means that parts or components with similar geometry and functionality may differ with respect to their name. In order to circumvent or master this challenge, the component names could be standardized by means of rules and/or artificial intelligence (AI). Classes of names of parts may be derived on the basis of such a standardization. Finally, each unique name of a part represents a class of parts, for example. In particular, the parts should be understood as meaning components or the components. On the basis of a list that may contain the standardized names of parts and identification numbers of parts, the content of the class can be calculated, that is to say a list of identification numbers of parts that relate to a plurality of vehicle projects. The identification number of a part is a designation for a part of a product such as an automobile and is generally unique for all products of a company. In this context, the term “combination type” is introduced and describes a combination, for example the combination 10, of a class of parts that are also referred to as components. In addition, the term “manufactured combination” is defined, for example, and represents an instance of a combination type that comprises a list of identification numbers of parts. In addition, information from all available data sources of the process chain, from planning to production, is additionally queried, for example, for each fabricated or manufactured combination belonging to a particular component type in order to obtain information for configuring a new production process. Naturally, the information content is higher in production processes that have a low performance during production. A plurality of performance indicators are generally available for production processes, for example a reject rate, a proportion of reworking and/or the productivity. All suitable indicators can be combined, for example, with the corresponding fabrication combination. The fabrication combinations with the highest information content can therefore be determined, for example. The case of the highest information content can be determined by analyzing the distribution of the combined performances with respect to the available fabrication combinations. If only one of the manufactured combinations has a low performance, for example, this should contain the highest information content.

A process with good performance characteristic values also has a high information content. This process could be used as a reference. The analysis of the combination types can show which combinations were previously used. This makes it possible to examine specific combinations of components.

If products or components of a company differ greatly from one another in terms of their geometry and/or functionality, a designer, for example, may prefer to concentrate on information relating to the manufactured combinations of similar products. This introduced similarity may be extended to conditions of the production process, such as a type of press line or individual features of parts, such as the material and/or the geometry. Consequently, it is possible to calculate a variable that indicates a sequence of a degree of correspondence in order to help a designer to find a reference combination. The manufactured combinations that have the greatest similarity and the best performance according to the performance indicators (performance characteristic values) introduced above are given the highest rank. Such combinations can be used as a reference for designing a new production process or new tools such as the tools 6 and 7 and therefore the tool set 5. Further information which does not, however, have any influence on the ranking can be additionally added to manufactured or machined combinations. An example could be the complexity of the combination. A so-called simple case could be a combination of two parts (components) which are geometrically connected by a plane of symmetry. The complexity increases if a plurality of parts without a geometric relationship with respect to one another are combined. A plurality of performance characteristic values of a manufacturing process can be combined to form a rank or a rank value. It would also be conceivable to combine the performance characteristic values and the rank to form a further rank or a further rank value. Against this background, the method could achieve at least the following advantages:
Overview of all previously used or manufactured combinations of a type of part in order to quickly and easily obtain suggestions for configuring a new production process for the same type of part.
Enhancement of an overview by automatically providing statistics relating to various performance indicators and similarities from various data sources in order to recommend a reference design.

The method makes it possible to identify combinations of parts with the highest information content and also enables further analyses, beyond provided statistics, on the basis of the determined identification numbers of parts.

The method does not require any excessive data analysis capabilities from persons, for example planners and designers of production processes.

### LIST OF REFERENCE SIGNS

1 Press
2 Press part
3 Press part
4 Double-headed arrow
5 Tool set
6 Tool
7 Tool
8 Component
9 Component
10 Combination
S1 First step
S2 Second step

1-13. (canceled)

14. A method for constructing at least one first tool set, wherein the at least one first tool set comprises: at least two first tools that can be used to simultaneously machine at least two first components in one stroke of a press, wherein the method comprises:
for a plurality of respective manufacturing processes which are carried out and each comprise at least one respective work process that was carried out multiple times in succession in the respective manufacturing process, wherein at least two further components were simultaneously machined in the respective work process in a respective stroke of the press or of a further press by means of two further tools of a respective further tool set: determining at least one respective performance characteristic value which belongs to the respective manufacturing process and characterizes the respective associated manufacturing process; and
constructing the first tool set based on the determined performance characteristic values.

15. The method of claim 14, wherein a sequence of performance characteristic values is created according to a predefined or predefinable rule, and wherein the first tool set is constructed on the basis of the sequence of performance characteristic values.

16. The method of claim 14, wherein:
first ones of the manufacturing processes are assigned to a first manufacturing process type on the basis of at least one first criterion; and
second ones of the manufacturing processes are assigned to a second manufacturing process type on the basis of at least one second criterion.

17. The method of claim 16,
wherein the first manufacturing processes are assigned to the first manufacturing process type if the first criterion is satisfied,
wherein the first criterion is satisfied if at least one difference between a first value and a second value is less than a predefinable or predefined threshold value,
wherein:
the first value characterizes at least one of the further components which were machined during the work processes of the first manufacturing processes, and/or characterizes at least one of the first manufacturing processes, and
the second value characterizes at least another one of the further components which were machined during the work processes of the first manufacturing processes, and/or characterizes at least another one of the first manufacturing processes, and
wherein the second manufacturing processes are assigned to the second manufacturing process type if the second criterion is satisfied, wherein the second criterion is satisfied if at least one difference between a third value and a fourth value is less than a predefinable or predefined threshold value,
wherein the third value characterizes at least one of the further components which were machined during the work processes of the second manufacturing processes, and/or characterizes at least one of the second manufacturing processes, and
wherein the fourth value characterizes another one of the further components which were machined during the work processes of the second manufacturing processes, and/or characterizes at least another one of the second manufacturing processes.

18. The method of claim 17, wherein the values characterize the same property of the respective component and/or of the respective manufacturing process.

19. The method of claim 18, wherein the property is or comprises a wall thickness and/or a material from which the respective component is formed, and/or a degree of forming and/or a dimension.

20. The method of claim 16, wherein at least one overall characteristic value characterizing the respective manufacturing process type is determined for the respective manufacturing process type from the performance characteristic values of the manufacturing processes assigned to the respective manufacturing process type.

21. The method of claim 20, wherein the first tool set is constructed based on the overall characteristic values.

22. The method of claim 20, wherein a sequence of overall characteristic values is created according to a predefined or predefinable rule.

23. The method of claim 22, wherein the first tool set is constructed based on the sequence of overall characteristic values.

24. A data processing device configured to execute the method of claim 14.

25. A non-transitory computer-readable medium comprising instructions which, when executed by a computer, causes the processor to execute the method of claim 14.
